(19) United States
(12) Patent Application Publication
(10) Pub. No.: US 2026/0213596 A1
(43) Pub. Date: Jul. 23, 2026

(54) PERMANENT MAGNET ROTOR AND METHOD FOR MANUFACTURING PERMANENT MAGNET ROTOR

(71) Applicant: Mitsubishi Electric Corporation, Chiyoda-ku, Tokyo (JP)

(72) Inventors: Takuya NAKAMURA, Tokyo (JP); Junji OKADA, Tokyo (JP); Yuichiro OHASHI, Tokyo (JP); Motoaki NISHIBU, Tokyo (JP)

(73) Assignee: Mitsubishi Electric Corporation, Chiyoda-ku, Tokyo (JP)

(21) Appl. No.: 19/144,548

(22) PCT Filed: Jan. 11, 2023
(86) PCT No.: PCT/JP2023/000445

§ 371 Date: Jun. 30, 2025

(51) Int. Cl. H02K 1/30; H02K 1/2733; H02K 15/035

(52) U.S. Cl. CPC H02K 1/30; H02K 1/2733; H02K 15/035

(57) ABSTRACT

A permanent magnet rotor includes a rotating shaft, an inner peripheral magnet that holds the rotating shaft and is a cylindrical bonded magnet, and an outer peripheral magnet that is provided on an outer peripheral side of the inner peripheral magnet and is a cylindrical bonded magnet. The inner peripheral magnet has, at one axial end of the inner peripheral magnet, a plurality of first recesses circumferentially disposed at equal intervals.

### FIELD

The present disclosure relates to a permanent magnet rotor and a method for manufacturing a permanent magnet rotor.

### BACKGROUND

A bonded magnet can be manufactured by injection molding as in a typical resin material. For this reason, a bonded magnet enables easier manufacture of a permanent magnet rotor and is widely used for, for example, a permanent magnet rotor for a fan motor of an air conditioner. In order to meet the recent demand for energy saving, the demand for increasing a magnetic force of a magnet has grown, and a ferrite bonded magnet is typically used, but a rare earth bonded magnet may in some cases be used. However, rare earth bonded magnets are expensive in material price.

Patent Literature 1 adopts a permanent magnet rotor having a two-layer structure, with a ferrite bonded magnet on an inner peripheral side and a bonded magnet made of a rare earth magnetic material on an outer peripheral side, thus achieving both performance and cost. Patent Literature 1 discloses that during molding of an outer peripheral magnet, magnetic poles formed in an inner peripheral magnet are attracted by a magnetic attraction force generated from a surface of a mold for the outer peripheral magnet to bring about position fixing of the magnetic poles.

### CITATION LIST

### Patent Literature

Patent Literature 1: Japanese Patent Application Laid-open No. 2005-151757

### SUMMARY OF INVENTION

### Problem to be Solved by the Invention

When the magnets are molded in a two-layer structure, a magnetic pole phase of the inner peripheral magnet needs to be aligned with a magnetic pole phase of the outer peripheral magnet. However, Patent Literature 1 has the following problems. That is, when the outer peripheral magnet is thick, the accuracy of the position fixing using the magnetic attraction force deteriorates and magnetic poles of the outer peripheral magnet and the inner peripheral magnet are misaligned with each other, thus causing, for example, lowered surface magnetic flux density, and an increase of torque ripple of a motor to be installed, which results from distorted magnetic flux.

The present disclosure has been made in view of the above circumstances, and an object of the present disclosure is to provide a permanent magnet rotor in which a magnetic pole phase of an inner peripheral magnet is aligned with a magnetic pole phase of an outer peripheral magnet.

### Means to Solve the Problem

To solve the above problems and achieve an object, a permanent magnet rotor according to the present disclosure includes: a rotating shaft; an inner peripheral magnet holding the rotating shaft and being a cylindrical bonded magnet; and an outer peripheral magnet provided on an outer peripheral side of the inner peripheral magnet and being a cylindrical bonded magnet. The inner peripheral magnet has, at one axial end of the inner peripheral magnet, a plurality of first recesses circumferentially disposed at equal intervals.

### Effects of the Invention

The permanent magnet rotor of the present disclosure has an effect of achieving the permanent magnet rotor in which the magnetic pole phase of the inner peripheral magnet is aligned with the magnetic pole phase of the outer peripheral magnet.

### BRIEF DESCRIPTION OF DRAWINGS

FIG. 1 is a perspective view illustrating a configuration of a permanent magnet rotor according to a first embodiment.

FIG. 2 is a sectional view illustrating the configuration of the permanent magnet rotor of the first embodiment.

FIG. 3 is a sectional view illustrating a configuration of one end of the permanent magnet rotor of the first embodiment.

FIG. 4 is a perspective view illustrating a configuration of the opposite end of the permanent magnet rotor of the first embodiment.

FIG. 5 is a top view illustrating a positional relationship between magnetic field lines for magnetic field orientation and weld lines in the permanent magnet rotor of the first embodiment.

FIG. 6 is a schematic plan view illustrating a positional relationship between the one end of the permanent magnet rotor of the first embodiment and a second magnetic field orientation mold.

FIG. 7 is a plan view illustrating a positional relationship among first recesses, magnetic pole centers, and weld lines in a magnet part of the permanent magnet rotor of the first embodiment.

FIG. 8 is a schematic plan view illustrating a positional relationship between the opposite end of the permanent magnet rotor of the first embodiment and the second magnetic field orientation mold.

FIG. 9 is a plan view illustrating a positional relationship among protrusions, the magnetic pole centers, and the weld lines in the magnet part of the permanent magnet rotor of the first embodiment.

FIG. 10 is a schematic diagram illustrating a magnetic flux distribution on an outer peripheral surface of the permanent magnet rotor according to the first embodiment.

FIG. 11 is a process chart illustrating a manufacturing process for the permanent magnet rotor in a second embodiment.

FIG. 12 is a sectional view illustrating a disassembled state of a first mold used in the manufacturing process of the second embodiment.

FIG. 13 is a plan view illustrating a first magnetic field orientation mold of the first mold of the second embodiment.

FIG. 14 is a sectional view illustrating an assembled state of the first mold used in the manufacturing process of the second embodiment.

FIG. 15 is a sectional view illustrating the inner peripheral magnet manufactured by using the first mold of the second embodiment.

FIG. 16 is a sectional view illustrating a disassembled state of a second mold used in the manufacturing process of the second embodiment.

FIG. 17 is a sectional view illustrating an assembled state of the second mold used in the manufacturing process of the second embodiment.

FIG. 18 is a sectional view illustrating the outer peripheral magnet manufactured by using the second mold of the second embodiment.

### DESCRIPTION OF EMBODIMENTS

Hereinafter, with reference to the drawings, a description will be given in detail of a permanent magnet rotor and a method for manufacturing a permanent magnet rotor according to embodiments.

### First Embodiment

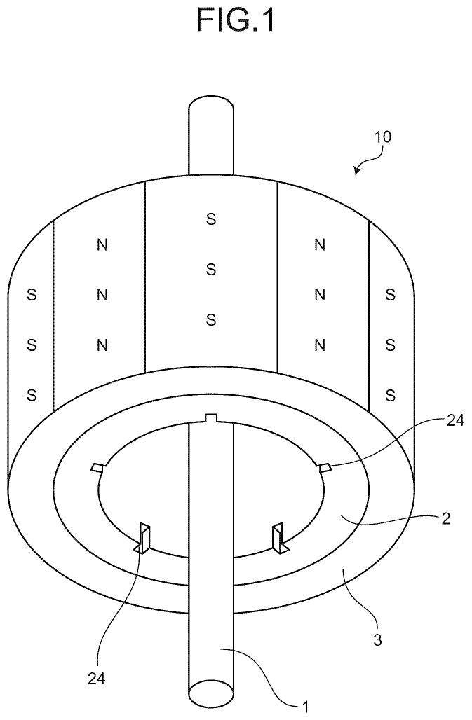

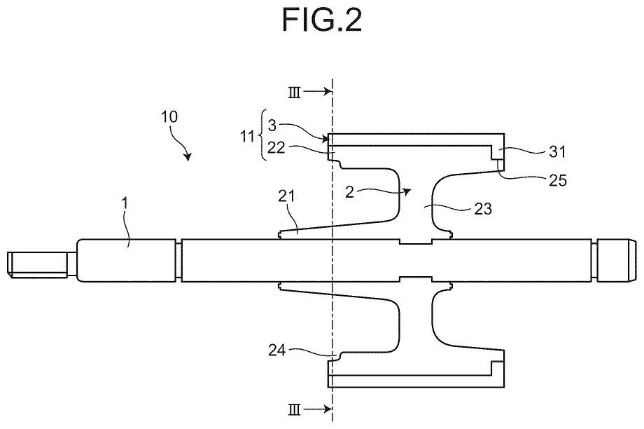

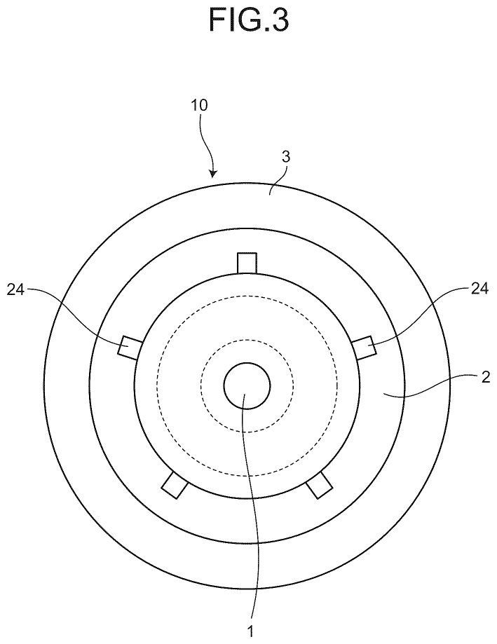

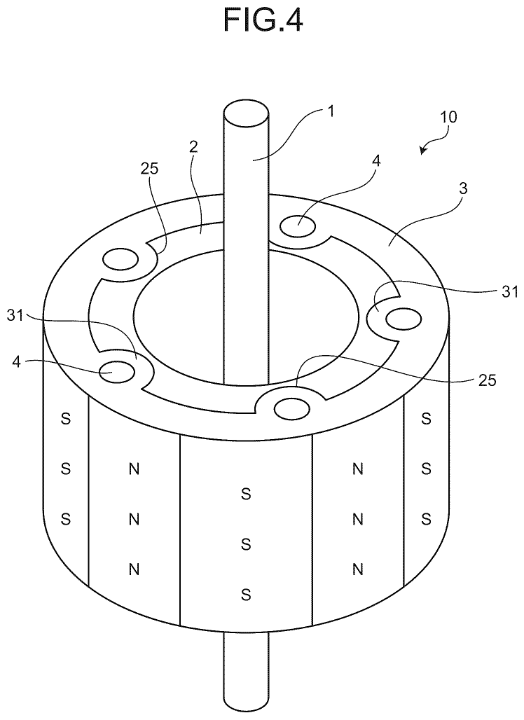

FIG. 1 is a perspective view illustrating a configuration of a permanent magnet rotor 10 according to a first embodiment. FIG. 2 is a sectional view illustrating the configuration of the permanent magnet rotor 10 of the first embodiment. FIG. 3 is a sectional view illustrating a configuration of one end of the permanent magnet rotor 10 of the first embodiment. FIG. 3 is a sectional view in the direction of arrows III-III in FIG. 2. FIG. 4 is a perspective view illustrating a configuration of the opposite end of the permanent magnet rotor 10 of the first embodiment.

As illustrated in FIGS. 1 to 4, the permanent magnet rotor 10 includes a rotating shaft 1, an inner peripheral magnet 2, and an outer peripheral magnet 3.

As illustrated in FIG. 2, the inner peripheral magnet 2 includes a shaft holding part 21, a magnetic force part 22, and a connection part 23. The shaft holding part 21 holds the rotating shaft 1 and is on an inner peripheral side of the inner peripheral magnet 2. The magnetic force part 22 is on an outer peripheral side of the inner peripheral magnet 2 and has a cylindrical shape. The connection part 23 connects the magnetic force part 22 and the shaft holding part 21. On the inner periphery of one axial end of the magnetic force part 22, as illustrated in FIG. 3, a plurality of first recesses 24 is provided. In the first embodiment, the number of magnetic poles of the permanent magnet rotor 10 is ten. Thus, five first recesses 24, corresponding to half the number of magnetic poles, are provided and are circumferentially disposed at equal intervals. The number of magnetic poles is the total number of the number of N poles and the number of S poles. The five first recesses 24 have the same shape and are provided only at the one axial end of the magnetic force part 22.

At the opposite axial end of the magnetic force part 22, that is, at the end opposite to the one end at which the first recesses 24 are formed, a plurality of second recesses 25 is provided as illustrated in FIG. 4.

The second recesses 25 are recessed from the outer edge side to the inner peripheral side of the magnetic force part 22 and are in the shape of a semicircular disc. In the first embodiment, the number of magnetic poles of the permanent magnet rotor 10 is ten. Thus, five second recesses 25, corresponding to half the number of magnetic poles, are provided and are circumferentially disposed at equal intervals. The second recesses 25 taken perpendicularly to the axial direction of the rotating shaft 1 each have a semicircular cross section. The five second recesses 25 have the same shape and are provided only at the opposite axial end of the magnetic force part 22.

The outer peripheral magnet 3 has a cylindrical shape. The outer peripheral magnet 3 includes a plurality of gate connection parts 4 and a plurality of semicircular disc-shaped protrusions 31 provided on the inner peripheral sides of the gate connection parts 4. The gate connection parts 4 are connected to gates, which are resin inlets in an injection molding machine. As illustrated in FIG. 2, the semicircular disc-shaped protrusions 31 each protruding toward the inner peripheral side are provided only at the opposite axial end of the outer peripheral magnet 3, that is, at the end on the side where the second recesses 25 are formed. The plurality of semicircular disc-shaped protrusions 31 is fitted into the plurality of semicircular disc-shaped second recesses 25 of the inner peripheral magnet 2.

The inner peripheral magnet 2 and the outer peripheral magnet 3 are bonded magnets, and are subjected to in-mold magnetic field orientation and formed by insert injection molding. The magnetic force part 22 of the inner peripheral magnet 2 and the outer peripheral magnet 3 constitute a magnet part 11, which functions as a magnet of the permanent magnet rotor 10. The inner peripheral magnet 2 and the outer peripheral magnet 3 have the same magnetic field orientation, and the magnetic poles of the inner peripheral magnet 2 and the outer peripheral magnet 3 are equalized.

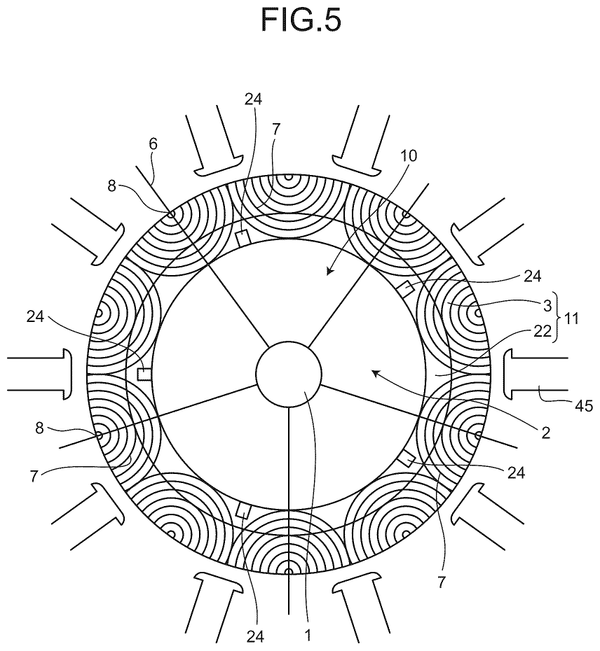

FIG. 5 is a top view illustrating a positional relationship between magnetic field lines for magnetic field orientation and weld lines in the permanent magnet rotor 10 of the first embodiment. FIG. 5 illustrates a state in which the permanent magnet rotor 10 is disposed in a magnetic field orientation mold. The magnetic field orientation mold illustrated in FIG. 5 corresponds to a first magnetic field orientation mold 43 and a second magnetic field orientation mold 53, both of which will be described later. Around the permanent magnet rotor 10, a plurality of tooth parts 45 of the magnetic field orientation mold is illustrated. Between the tooth part 45 and the tooth part 45, a magnetic field orienting magnet (not illustrated) is disposed. FIG. 5 illustrates concentric magnetic field lines 7 formed in the magnet part 11 of the permanent magnet rotor 10 by the magnetic field orientation mold.

As illustrated in FIG. 5, in the first embodiment, the number of magnetic poles of the permanent magnet rotor 10 is ten. Since the number of magnetic poles is ten, the magnetic field lines 7 are generated at ten locations. The first recesses 24 are provided at equal intervals at five locations of positions facing the plurality of tooth parts 45. In the first embodiment, the first recesses 24 are provided so as to face the five tooth parts 45 out of the ten tooth parts 45. A weld line 6 is disposed in an intermediate area between adjacent ones of the plurality of tooth parts 45. For an interpole 8, which is an intermediate position between the adjacent magnetic poles, the magnetic field orientation is effected so as to be at the same position as the weld line 6. In the first embodiment, since a magnetic resin material is simultaneously injected through the plurality of gate connection parts 4, five weld lines 6 are formed at positions that are circumferentially intermediate between adjacent ones of the plurality of gate connection parts 4.

Next, a description will be given of the first recesses 24 provided on the inner periphery of the one end of the magnetic force part 22 of the inner peripheral magnet 2. The outer peripheral magnet 3 is insert injection molded on the outer peripheral side of the inner peripheral magnet 2. At that time, the inner peripheral magnet 2 needs to be set in the mold so as to align in rotation-directional phase with a second magnetic field orienting magnet disposed in the second magnetic field orientation mold 53 (to be described later) for subjecting the outer peripheral magnet 3 to magnetic field orientation. The first recesses 24 provided on the inner periphery of the magnetic force part 22 of the inner peripheral magnet 2 are set in alignment with protrusions 62 provided in a second mold 50 (to be described later) in which the second magnetic field orientation mold 53 is disposed, to ensure that the first recesses 24 are positioned with high accuracy.

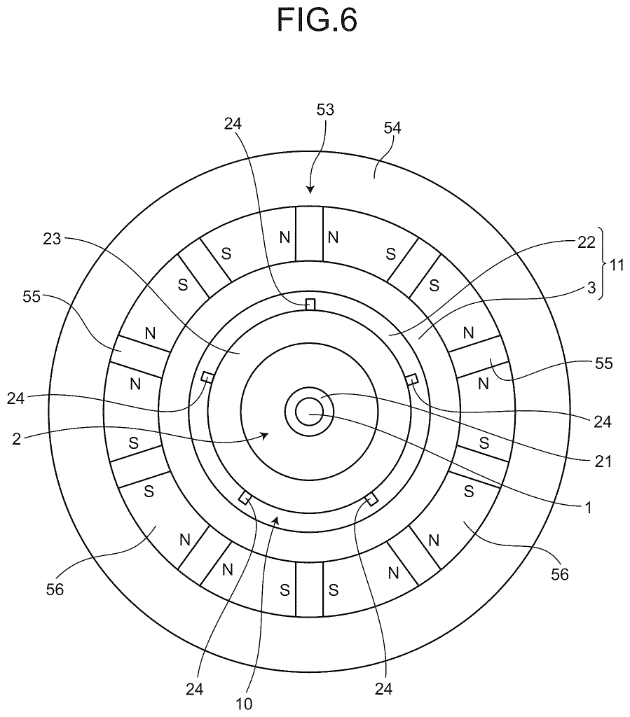

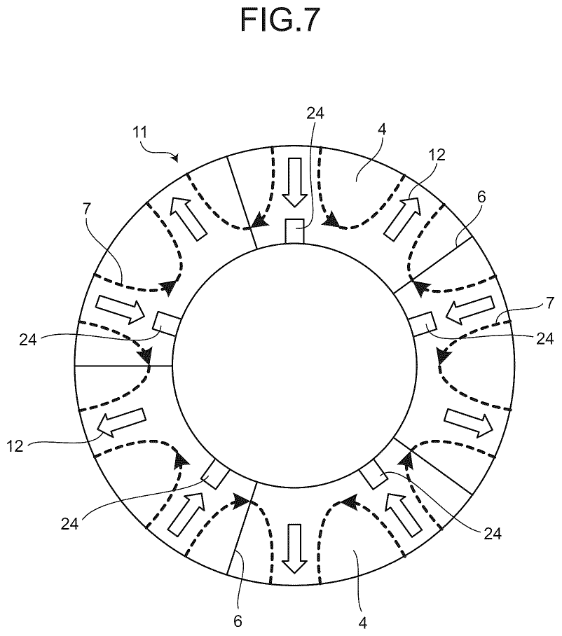

Next, the circumferential positions of the first recesses 24 will be described with reference to FIGS. 6 and 7. FIG. 6 is a schematic plan view illustrating a positional relationship between the one end of the permanent magnet rotor 10 of the first embodiment and the second magnetic field orientation mold 53. FIG. 7 is a plan view illustrating a positional relationship among first recesses 24, magnetic pole centers 12, and the weld lines 6 in the magnet part 11 of the permanent magnet rotor 10 of the first embodiment. The second magnetic field orientation mold 53 is a mold for insert resin molding and magnetization of the outer peripheral magnet 3. The second magnetic field orientation mold 53 includes an outer peripheral yoke 54 having a cylindrical shape, a plurality of tooth parts 55, and a plurality of magnetic field orienting magnets 56. The plurality of tooth parts 55 extends from the outer peripheral yoke 54 toward the inner periphery, and are circumferentially equally disposed. The plurality of magnetic field orienting magnets 56 is disposed between adjacent ones of the tooth parts 55. The magnetic field orienting magnets 56 are alternately disposed such that directions of the N poles and the S poles are directed in the circumferential direction, and the N poles face each other and the S poles face each other in adjacent ones of the magnetic field orienting magnets 56. The arrangement of the magnetic field orienting magnets 56 as described above allows the N pole and the S pole to be formed between adjacent ones of the tooth parts 55, and magnetic fields to be formed from the adjacent tooth parts 55 to the magnet part 11 in the direction of the magnetic field lines 7 (see FIG. 7).

Each of the first recesses 24 of the inner peripheral magnet 2 is disposed to face corresponding one of the tooth parts 55 of the second magnetic field orientation mold 53. That is, due to the magnetic field orientation by the second magnetic field orientation mold 53, as illustrated in FIG. 7, the magnetic pole center 12 is formed in the portion of the magnet part 11 facing each tooth part 55 and no magnetic pole is formed on the inner peripheral side. Thus, each of the first recesses 24 is disposed at a position at which the magnetic force on the inner peripheral side of the magnet part 11 is zero. The magnetic pole center 12 is a center position of the magnetic poles.

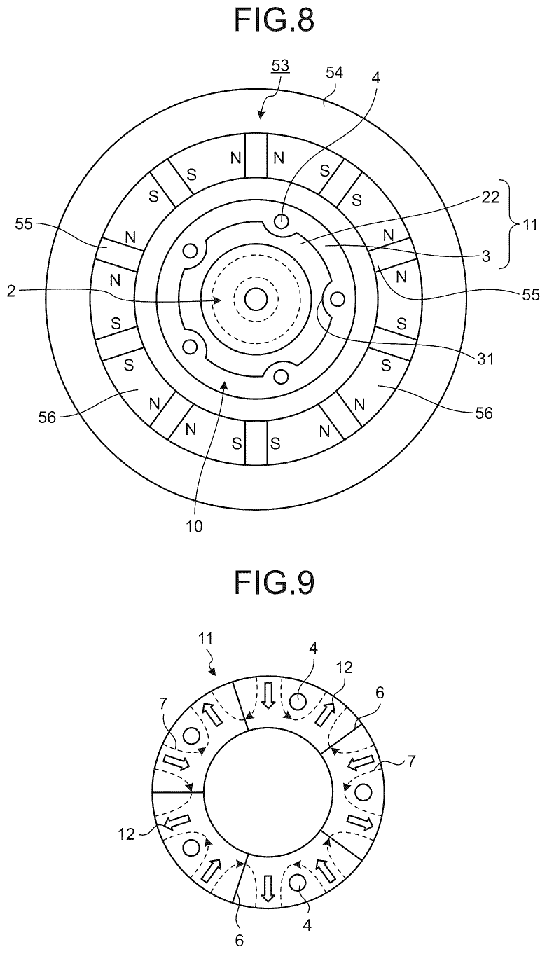

Next, a description will be given in detail of the semicircular disc-shaped protrusions 31 of the outer peripheral magnet 3 and the semicircular disc-shaped second recesses 25 of the inner peripheral magnet 2. FIG. 8 is a schematic plan view illustrating a positional relationship between the opposite end of the permanent magnet rotor 10 of the first embodiment and the second magnetic field orientation mold 53. FIG. 9 is a plan view illustrating a positional relationship among the protrusions 31, the magnetic pole centers 12, and the weld lines 6 in the magnet part 11 of the permanent magnet rotor 10 of the first embodiment. The outer peripheral magnet 3 is insert injection molded so as to fill the second recesses 25 of the inner peripheral magnet 2. In the permanent magnet rotor 10 of the first embodiment, the protrusions 31 of the outer peripheral magnet 3 are fitted into the second recesses 25 of the inner peripheral magnet 2. This can improve joint strength between the inner peripheral magnet 2 and the outer peripheral magnet 3 in the rotation direction. Additionally, the fitting of the protrusions 31 into the second recesses 25 at the axial end can improve axial tensile strength between the inner peripheral magnet 2 and the outer peripheral magnet 3.

As illustrated in FIG. 8, the five protrusions 31 of the outer peripheral magnet 3 are disposed in intermediate areas between adjacent ones of the tooth parts 55 of the second magnetic field orientation mold 53. That is, the magnetic field orientation by the second magnetic field orientation mold 53 allows, as illustrated in FIG. 9, the magnetic pole center 12 to be formed in the portion of the magnet part 11 facing each tooth part 55. Thus, each of the protrusions 31 is disposed in an intermediate area between adjacent ones of the magnetic pole centers 12 in the magnet part 11.

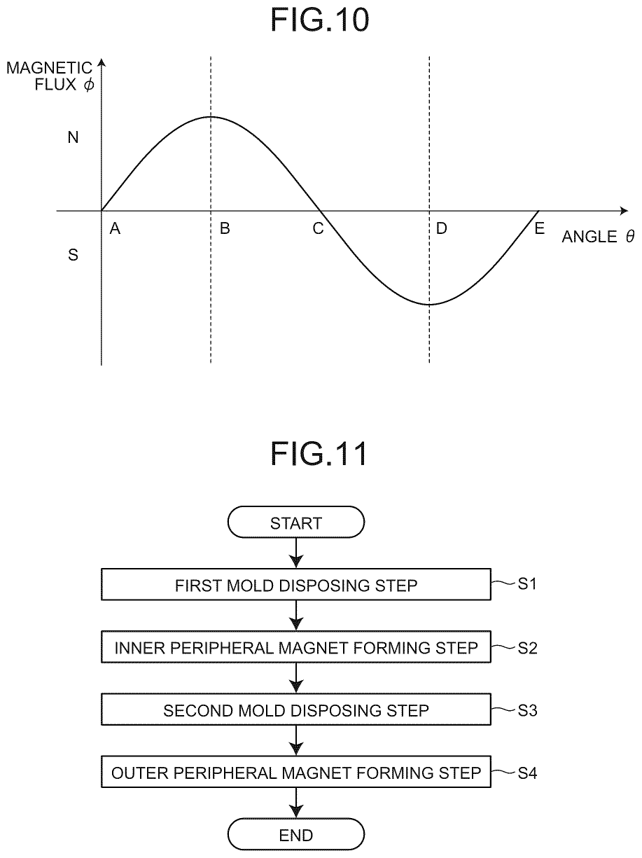

FIG. 10 is a schematic diagram illustrating a magnetic flux distribution on an outer peripheral surface of the permanent magnet rotor 10 according to the first embodiment. The horizontal axis represents the angle θ, and the vertical axis represents the magnetic flux Φ Here, A to C correspond to N poles, and C to E correspond to S poles. In a case where the number of magnetic poles is ten, when A is 0°, C is 36° and E is 72°. The magnetic flux distribution is sinusoidal. Here, A indicates a boundary position between the S pole and the N pole, and C indicates a boundary position between the N pole and the S pole. Here, B indicates the position of the maximum magnetic flux value of the N pole and indicates the magnetic pole center of the N pole. Here, D indicates the position of the maximum magnetic flux value of the S pole and indicates the magnetic pole center of the S pole. As illustrated in FIG. 6, when each of the first recesses 24 is disposed at an angle facing the tooth part 55 and magnetized, on the outer peripheral surface side of the permanent magnet rotor 10, the angle of the tooth part 55 is the center of the magnetic poles, and the intermediate position between adjacent ones of the tooth parts 55 is the boundary position between the N pole and the S pole. Thus, either the magnetic pole center of the N pole or the magnetic pole center of the S pole is disposed at an angle corresponding to the first recess 24.

As described above, in the first embodiment, since the first recesses 24 are provided at equal intervals in number corresponding to half the number of magnetic poles of the permanent magnet rotor 10 and are disposed at positions at which the magnetic force by which the magnetic fields are oriented in the mold is zero, it is possible to reduce the magnetic force distortion as much as possible. The first recesses 24 are disposed at the one axial end of the inner peripheral magnet 2. This arrangement enables positioning when the permanent magnet rotor 10 is molded from axially above and below using an upper mold and a lower mold. Additionally, the first recesses 24 are formed on the inner peripheral surface of the magnetic force part 22 of the inner peripheral magnet 2. This arrangement can reduce the influence on the magnetic flux of the permanent magnet rotor 10.

The number of first recesses 24 is, for example, five when the number of magnetic poles is ten, and is, for example, ten when the number of magnetic poles is twenty. Alternatively, when the number of magnetic poles is twenty, the number of first recesses 24 may be five. That is, the number of first recesses 24 is only required to 1/(2N) (N is a natural number) of the number of magnetic poles. Furthermore, it is more desirable to make the number of first recesses 24 a prime number. Making the number of first recesses 24 a prime number can reduce an electromagnetic excitation force mode. For example, when the number of magnetic poles is twenty and the number of first recesses 24 is ten, since two-fold rotational symmetry occurs with respect to the entire circumference of the rotating shaft, an electromagnetic excitation force having a frequency of two times with respect to one rotation is generated. By making the number of first recesses 24 a prime number, only frequencies corresponding to the entire circumference and to the number of first recesses 24 are generated, thus an excitation force having unnecessary frequencies can be reduced.

### Second Embodiment

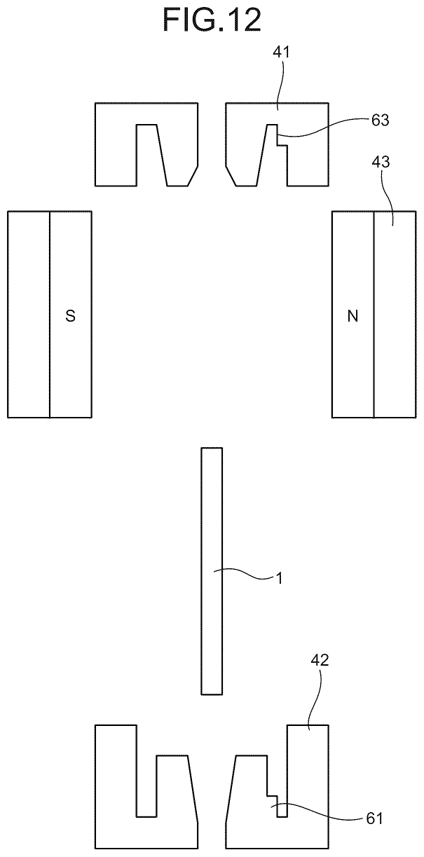

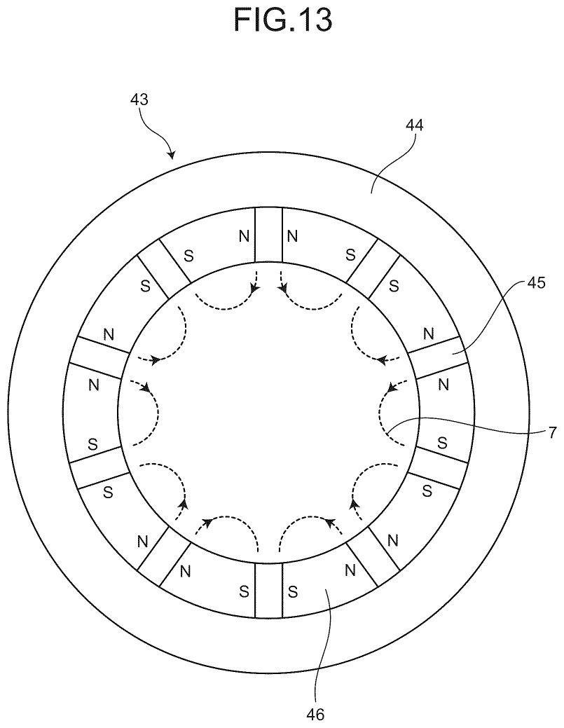

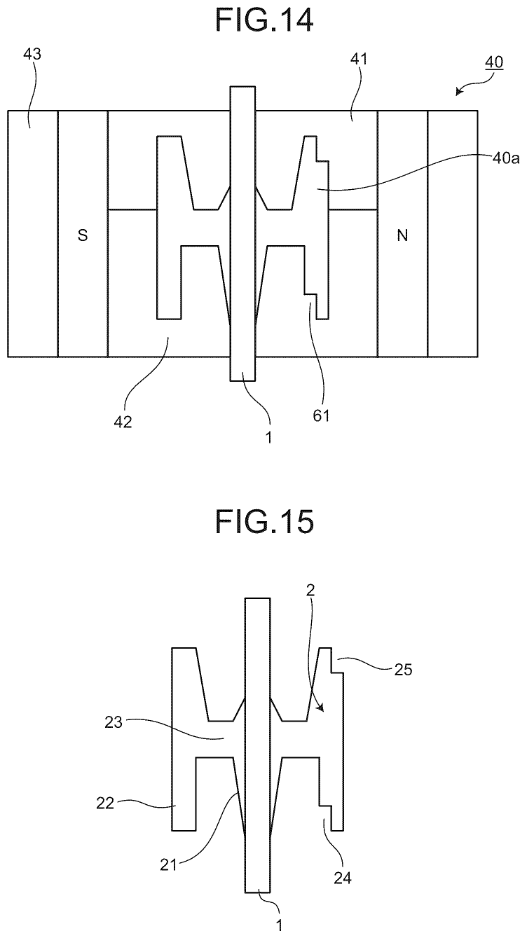

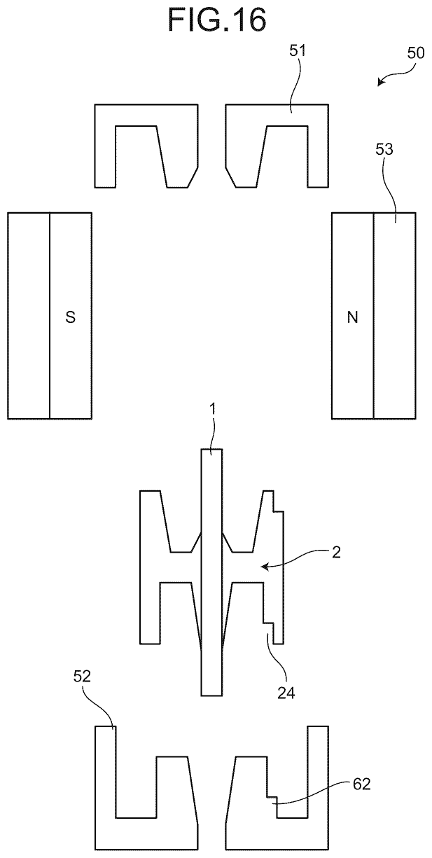

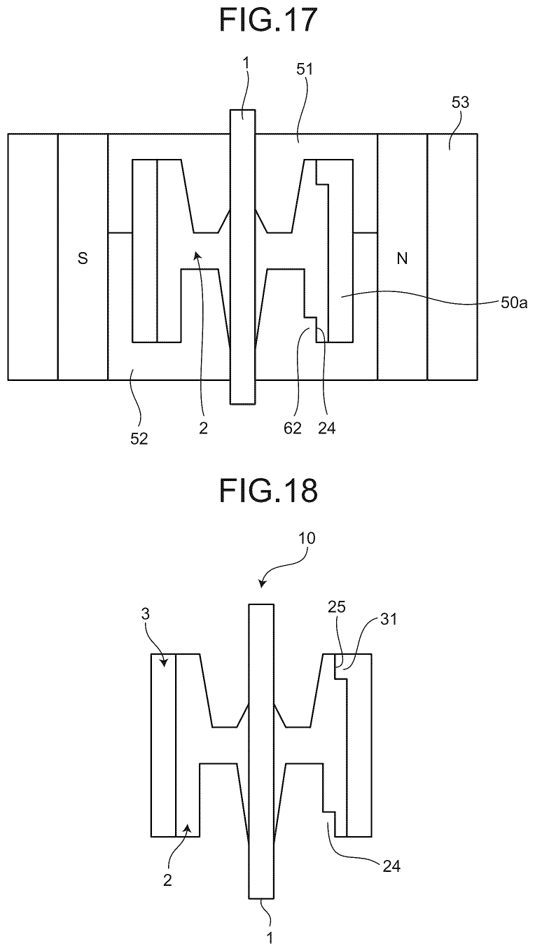

In a second embodiment, a method for manufacturing the permanent magnet rotor 10 will be described. FIG. 11 is a process chart illustrating a manufacturing process for the permanent magnet rotor 10 in the second embodiment. FIG. 12 is a sectional view illustrating a disassembled state of a first mold 40 used in the manufacturing process of the second embodiment. FIG. 13 is a plan view illustrating the first magnetic field orientation mold 43 of the first mold 40 of the second embodiment. FIG. 14 is a sectional view illustrating an assembled state of the first mold 40 used in the manufacturing process of the second embodiment. FIG. 15 is a sectional view illustrating the inner peripheral magnet 2 manufactured by using the first mold 40 of the second embodiment. FIG. 16 is a sectional view illustrating a disassembled state of the second mold 50 used in the manufacturing process of the second embodiment. FIG. 17 is a sectional view illustrating an assembled state of the second mold 50 used in the manufacturing process of the second embodiment. FIG. 18 is a sectional view illustrating the outer peripheral magnet 3 manufactured by using the second mold 50 of the second embodiment.

As illustrated in FIG. 18, the permanent magnet rotor 10 is manufactured by forming the inner peripheral magnet 2 around the rotating shaft 1 and forming the outer peripheral magnet 3 on the outer periphery of the inner peripheral magnet 2.

### First Mold Disposing Step (Step S1)

As illustrated in FIG. 12, the first mold 40 includes a first upper mold 41, a first lower mold 42, and the first magnetic field orientation mold 43. As illustrated in FIG. 14, the rotating shaft 1 is placed through the center hole of the first upper mold 41 and the center hole of the first lower mold 42 to form a first space 40a surrounded by the first upper mold 41 and the first lower mold 42. The first magnetic field orientation mold 43 is disposed on the outer peripheries of the first upper mold 41 and the first lower mold 42. The first lower mold 42 has a plurality of protrusions 61 for forming the plurality of first recesses 24. Additionally, the first upper mold 41 has a plurality of protrusions 63 for forming the plurality of second recesses 25.

The first magnetic field orientation mold 43 is a mold for insert resin molding of and magnetization of the inner peripheral magnet 2. As illustrated in FIG. 13, the first magnetic field orientation mold 43 includes an outer peripheral yoke 44 having a cylindrical shape, the plurality of tooth parts 45, and the plurality of magnetic field orienting magnets 46. The plurality of tooth parts 45 extend from the outer peripheral yoke 44 toward the inner periphery, and is circumferentially equally disposed. The plurality of magnetic field orienting magnets 46 is disposed between adjacent ones of the tooth parts 45. The magnetic field orienting magnets 46 are alternately disposed such that directions of the N poles and the S poles face in the circumferential direction, and the N poles face each other and the S poles face each other in adjacent ones of the magnetic field orienting magnets 46. The arrangement of the magnetic field orienting magnets 46 as described above allows the N pole and the S pole to be formed between adjacent ones of the tooth parts 45, and magnetic fields to be formed from the adjacent tooth parts 45 to the centers in the direction of the magnetic field lines 7.

### Inner Peripheral Magnet Forming Step (Step S2)

With the magnetic fields formed in the first space 40a, a first magnetic resin material is injection molded through the gate of the first upper mold 41. The first magnetic resin material is, for example, an anisotropic ferrite bonded magnet material. Consequently, as illustrated in FIG. 15, around the rotating shaft 1, the inner peripheral magnet 2 is formed in which the anisotropic magnetic resin material is oriented in the direction of the magnetic field lines 7 and that is magnetized so as to correspond to the shape of the first space 40a and the direction of the magnetic field lines 7 formed by the magnetic field orienting magnet 46. At the one axial end of the inner peripheral magnet 2, the first recesses 24 are formed by using the protrusions 61 of the first lower mold 42. Additionally, at the opposite axial end of the inner peripheral magnet 2, the second recesses 25 are formed by using the protrusions 63 of the first upper mold 41.

### Second Mold Disposing Step (Step S3)

As illustrated in FIG. 16, the second mold 50 includes a second upper mold 51 having a gate, a second lower mold 52 having the protrusions 62 to be fitted into the first recesses 24, and the second magnetic field orientation mold 53. As illustrated in FIG. 17, the rotating shaft 1 held by the inner peripheral magnet 2 is placed through the center hole of the second upper mold 51 and the center hole of the second lower mold 52 to form a second space 50a surrounded by the second upper mold 51 and the second lower mold 52. The second magnetic field orientation mold 53 is disposed on the outer peripheries of the second upper mold 51 and the second lower mold 52. The second magnetic field orientation mold 53 has the same shape and the same number of magnetic poles as the first magnetic field orientation mold 43. At this time, the first recesses 24 of the inner peripheral magnet 2 and the protrusions 62 provided in the second lower mold 52 of the second mold 50 are used to perform positioning in the rotation direction such that the magnetic pole centers 12 formed in the inner peripheral magnet 2 coincide with the magnetic pole centers 12 formed by the second magnetic field orientation mold 53.

### Outer Peripheral Magnet Forming Step (Step S4)

With the magnetic fields formed in the second space 50a, a second magnetic resin material is injection molded through the plurality of gates of the second upper mold 51. The second magnetic resin material is, for example, an anisotropic rare earth bonded magnet material. Consequently, the second magnetic resin material is injected into the second space 50a through the plurality of gate connection parts 4. Thus, as illustrated in FIG. 18, on the outer periphery of the inner peripheral magnet 2, the outer peripheral magnet 3 is formed in which the anisotropic magnetic resin material is oriented in the direction of the magnetic field lines 7 and that is magnetized so as to correspond to the shape of the second space 50a and the direction of the magnetic field lines 7 formed by the magnetic field orienting magnet 56, thus completing the permanent magnet rotor 10. The plurality of protrusions 31 to be fitted into the plurality of second recesses 25 is formed at one end of the outer peripheral magnet 3.

According to the second embodiment, the first recesses 24 of the inner peripheral magnet 2 and the protrusions 62 provided in the second lower mold 52 of the second mold 50 are used to perform positioning in the rotation direction such that the magnetic pole centers 12 formed in the inner peripheral magnet 2 coincide with the magnetic pole centers 12 formed by the second magnetic field orientation mold 53. This can easily provide the permanent magnet rotor 10 in which the magnetic pole phase of the inner peripheral magnet 2 is aligned with the magnetic pole phase of the outer peripheral magnet 3.

Note that in the above description, the protrusions 62 to be fitted to the first recesses 24 are provided in the second lower mold 52 of the second mold 50, but the protrusions 62 to be fitted to the first recesses 24 may be provided in the second upper mold 51 of the second mold 50.

The features illustrated in connection with the above embodiments are an example of the details of the present disclosure, and may be combined with other known techniques, or may partially be omitted or changed without going beyond the scope of the present disclosure.

### REFERENCE SIGNS LIST

1 rotating shaft; 2 inner peripheral magnet; 3 outer peripheral magnet; 4 gate connection part; 6 weld line; 7 magnetic field line; 8 interpole; 10 permanent magnet rotor; 11 magnet part; 12 magnetic pole center; 21 shaft holding part; 22 magnetic force part; 23 connection part; 24 first recess; 25 second recess; 31, 61, 62, 63 protrusion; 40 first mold; 40a first space; 41 first upper mold; 42 first lower mold; 43 first magnetic field orientation mold; 44, 54 outer peripheral yoke; 45, 55 tooth part; 46, 56 magnetic field orienting magnet; 50 second mold; 50a second space; 51 second upper mold; 52 second lower mold; 53 second magnetic field orientation mold.

1. A permanent magnet rotor comprising:
a rotating shaft;
an inner peripheral magnet holding the rotating shaft and being a cylindrical bonded magnet; and
an outer peripheral magnet provided on an outer peripheral side of the inner peripheral magnet and being a cylindrical bonded magnet, wherein
the inner peripheral magnet has, at one axial end of the inner peripheral magnet, a plurality of first recesses circumferentially disposed at equal intervals, and
with respect to an angle about the rotating shaft, the plurality of first recesses is disclosed at angles that coincide with angles of magnetic pole centers of N poles or S poles of the inner peripheral magnet and the outer peripheral magnet.

2. The permanent magnet rotor according to claim 1, wherein a number of the plurality of first recesses is 1/(2N) of a number of magnetic poles formed in the inner peripheral magnet and the outer peripheral magnet, where N is a natural number.

3. The permanent magnet rotor according to claim 2, wherein the number of the plurality of first recesses is a prime number.

4. (canceled)

5. The permanent magnet rotor according to claim 1, wherein the plurality of first recesses is formed disposed at positions at which a magnetic force on an inner peripheral side of the inner peripheral magnet in zero.

6. The permanent magnet rotor according to claim 1, wherein
the plurality of first recesses is provided at the one axial end of the inner peripheral magnet,
the inner peripheral magnet has, on an outer peripheral side of an opposite axial end of the inner peripheral magnet, a plurality of second recesses, and
the outer peripheral magnet has a plurality of protrusions each protruding toward the inner peripheral side and to be fitted to the plurality of second recesses of the inner peripheral magnet.

7. A method of manufacturing a permanent magnet rotor, the method comprising:
disposing, around a rotating shaft, a first mold including a first upper mold, a first lower mold, and a first magnetic field orientation mold, the first mold being a mold for forming an inner peripheral magnet that is a bonded magnet and has a plurality of first recesses disposed at equal intervals in a circumferential direction at one axial end of the inner peripheral magnet;
injection molding a first magnetic resin material into a first space surrounded by the first mold to form the inner peripheral magnet holding the rotating shaft and having the plurality of first recesses at the one axial end of the inner peripheral magnet;
disposing, around the inner peripheral magnet, a second mold including a second upper mold, a second lower mold, and a second magnetic field orientation mold, the second mold being a mold for forming an outer peripheral magnet that is a bonded magnet; and
injection molding a second magnetic resin material into a second space surrounded by the second mold to form the outer peripheral magnet on an outer side of the inner peripheral magnet holding the rotating shaft, wherein
with respect to an angle about the rotating shaft, the plurality of first recesses is disposed at angles that coincide with angles of magnetic pile centers of N poles or S poles of the inner peripheral magnet and the other peripheral magnet,
the second mold has a plurality of protrusions to be fitted to the plurality of first recesses of the inner peripheral magnet, and
in the injections molding the second magnetic resin material, the plurality of protrusions and the plurality of first recesses are used to perform positioning in a rotation direction to position the inner peripheral magnet and the second mold.
